(19) United States
(12) Patent Application Publication
(10) Pub. No.: US 2006/0246307 A1
(43) Pub. Date: Nov. 2, 2006

(54) Bio-degradable paper board

(76) Inventor: Hsi-Ching Chang, Chang-Hua (TW)

Correspondence Address: CHANG HSI-CHING, P.O.BOX 487, CHANG-HUA CITY, 500, TW

(21) Appl. No.: 11/171,426

(22) Filed: Jul. 1, 2005

(30) Foreign Application Priority Data
Apr. 27, 2005 (TW) 094206557

(51) Int. Cl. B32B 27/10; B32B 27/36

(52) U.S. Cl. 428/481; 428/537.5; 428/535

(57) ABSTRACT

A bio-degradable paper board includes a paper board and a bio-degradable layer is coated to the paper board by extrusion-coating machine. The bio-degradable layer is a layer of Polylactic Acid (PLA), Polyethylene Terephthalate (PET) or corn starch.

### FIELD OF THE INVENTION

The present invention relates to a biodegradable paper board having a coating made by Polylactic Acid (PLA), Polyethylene Terephthalate (PET) or corn starch material and food is stored in a box made by the biodegradable board and in contact with the coating.

### BACKGROUND OF THE INVENTION

A conventional food box made by paper material generally includes a paper board and a layer which is glued to the outside of the food box. The layer includes printed patters and does not contact the food. The layer is made by polyethylene (PE), polypropylene (PP), polyvinyl chloride (PVC) or corn starch. Only the corn starch is biodegradable. The layer has to be made to have a certain thickness and patterns are printed on the layer before the layer is glued to the food box. An adhesive is located between the outside of the paper box and the layer. Besides, the layer is not directly connected to the food box, the layer might be peeled off if the adhesive is not applied evenly on the surface of the paper-made food box. Furthermore, the layer has to be made to have a certain thickness so that it includes a higher manufacturing cost. Most important is that PE, PP and PVC cannot be bio-degraded.

The present invention intends to provide a bio-degradable paper board which can be made into food boxes and includes a layer of PET or PLA which is coated on the paper board directly by extrusion-coating machine.

### SUMMARY OF THE INVENTION

The present invention relates to a bio-degradable paper board that comprises a paper board and a bio-degradable layer is coated to the paper board by extrusion-coating machine. The bio-degradable layer can be a layer of Polylactic Acid (PLA), Polyethylene Terephthalate (PET) or corn starch. The paper board with the bio-degradable layer can be made to be food containers and the bio-degradable layer can be in contact with food directly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a paper roll of the present invention, and

FIG. 2 is a cross sectional view to show the bio-degradable layer on the paper board.

### DETAILED DESCRIPTION OF THE PREFERRED EMBODIMENT

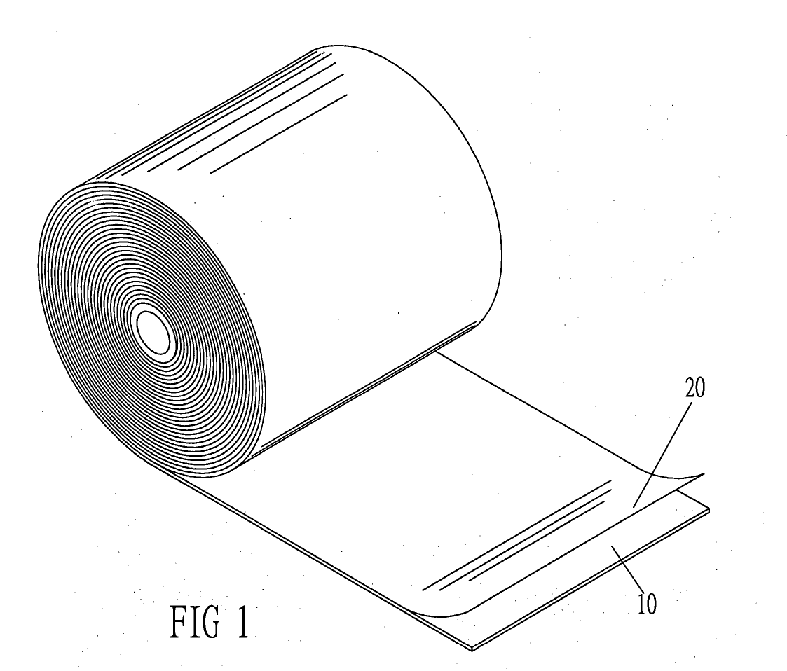

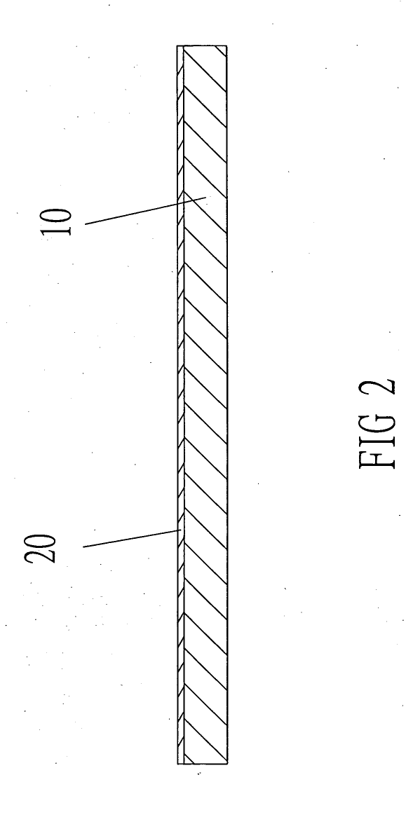

Referring to FIGS. 1 and 2, the paper board 10 of the present invention is in a form of a paper roll and a biodegradable layer 20 is coated to the paper board 10 by extrusion-coating machine. The bio-degradable layer 20 is a layer of Polylactic Acid (PLA), Polyethylene Terephthalate (PET) or corn starch.

The bio-degradable layer 20 can be made from PET such as Biomax PET by Dupond, bio-degradable PET particles by Far-Eastern Textile Ltd (Taiwan), Polylactic Acid (PLA) particles by Nature works L.L.C., or corn starch. The material is heated to be liquid and extruded by an extruder and the liquid is extruded by T-Die to be foam-type layer 20. The paper board 10 is in a form of a paper roll which is pre-heated and then treated by corona treatment.

The foam type layer 20 is applied on the paper board 10 and both of which are fed between silicon rollers and cooling rollers to evenly press the layer 20 on the paper board 10. The material of the layer 20 is combined with fibers of the paper board 10. The pressed paper board 10 and the layer 20 are then treated by another corona treatment to open the orifices of the paper board 10. The paper board 10 is then can be cut and folded to be food containers.

There is no adhesive located between the bio-degradable layer 20 and the paper board 10 and the bio-degradable layer 20 does not need to be made to be a certain thickness so that the procedures are simplified and the manufacturing cost is reduced. The paper board 10 and the layer 20 are both bio-degradable and the material of the bio-degradable layer 20 can be degraded into water and carbon dioxide within few months. The paper board 10 is sold in a form of paper roll which can be cut as desired.

While we have shown and described the embodiment in accordance with the present invention, it should be clear to those skilled in the art that further embodiments may be made without departing from the scope of the present invention.

What is claimed is:

1. A bio-degradable paper board comprising:
a paper board and a bio-degradable layer being coated to the paper board by extrusion-coating machine.

2. The paper board as claimed in claim 1, wherein the biodegradable layer is a layer of Polylactic Acid (PLA).

3. The paper board as claimed in claim 1, wherein the biodegradable layer is a layer of PET.

4. The paper board as claimed in claim 1, wherein the bio-degradable layer is a layer of corn starch.
